(19) United States
(12) Patent Application Publication
(10) Pub. No.: US 2017/0094367 A1
(43) Pub. Date: Mar. 30, 2017

(54) Text Data Associated With Separate Multimedia Content Transmission

(71) Applicant: Michael Evan Crabb, Carmel, IN (US)

(72) Inventor: Michael Evan Crabb, Carmel, IN (US)

(73) Assignee: Thomson Licensing

(21) Appl. No.: 14/864,109

(22) Filed: Sep. 24, 2015

(51) Int. Cl. H04N 21/488; H04N 21/43; H04N 21/61; H04N 21/81; H04N 21/462; H04N 21/41; H04N 21/431

(52) U.S. Cl. CPC H04N 21/4884; H04N 21/4122; H04N 21/4126; H04N 21/4307; H04N 21/4312; H04N 21/8133; H04N 21/4622; H04N 21/6125

(57) ABSTRACT

Text data associated with multimedia content is transmitted to a mobile device while the multimedia content is shown on a separate network and remote apparatus. The mobile device requests the text data associated with the multimedia content and can optionally send hints to help determine which multimedia content text should be transmitted. The received text data is rendered in a scrollable, temporal representation, allowing recall of prior text associated with past multimedia content images.

### TECHNICAL FIELD

The present principles relate to the display of text associated with multimedia content and, in particular, to techniques for streaming text to one device while multimedia content is displayed on a separate device.

### BACKGROUND

Closed captioning may be used to provide a textual representation of audio played back with video. For example, closed captioning text may be displayed simultaneously with video at a designated section of the display, such as near the bottom or near the top of the screen. Such text may help the hearing impaired or may help a user watch video filmed in a foreign language. Closed captioning is deemed “closed” due to the text not being a permanent part of the video; rather, the text may be turned on or off as desired.

### SUMMARY

As noted above, closed captioning may be displayed simultaneously with multimedia content at a designated section of the display. However, displaying text data, such as closed captioning, simultaneously with the multimedia content may obscure part of the multimedia content. When watching multimedia content in a group, some viewers may prefer displaying text data and others may not. Thus, text data may be irritating for those viewers that do not need it, but use it to respect those that request text data. Additionally, the text data graphics may be compromised, since they are designed for display on a small designated section of a screen. Such a compromise may limit the text graphics quality to the capabilities of the display device being used. In addition, some may desire the text data to be in different languages and, thus, cause a conflict between text data users.

In view of the foregoing, the present principles provide apparatuses, non-transitory computer-readable mediums, and methods for displaying text data associated with multimedia content playback. In one example, an apparatus can include a network interface and at least one processor configured to: detect, via the network interface, a request from a first remote apparatus for a text data stream that is associated with a multimedia content stream; and transmit, via the network interface, the text data stream to the first remote apparatus while the multimedia content stream is transmitted separately to a second remote apparatus.

In a further example, the text data stream can be transmitted over a first network and the multimedia content stream can be transmitted over a second network. In yet another example, the first network can be the Internet and the second network can be a multimedia content delivery network. In another aspect, the text data stream can be updated using a text database at a rate of approximately once per second and a data rate for the text data stream can be identified such that the text data stream is synchronized with that of the multimedia content stream. In one example, the text data stream and the multimedia content stream are live broadcasts. In a further example, when the text data stream and the multimedia content stream are pre-recorded, the text data stream can be synchronized with the multimedia content stream such that a synchronization delay therebetween is no greater than approximately 5 seconds.

In another aspect of the present principles, a method can include detecting a request from a first remote apparatus for a text data stream that is associated with a multimedia content stream, and transmitting the text data stream to the first remote apparatus while the multimedia content stream is transmitted separately to a second remote apparatus.

In yet another aspect, a further apparatus is disclosed. Such apparatus can include a network interface; a memory; and at least one processor configured to: transmit, via the network interface, a request for text data that is associated with multimedia content images displayed on a remote apparatus; receive, via the network interface, the text data; store the text data in the memory; render a scrollable, temporal representation of the text data; and render a selected portion of the text data. In another example, the at least one processor is further configured to display the text data while corresponding multimedia content images are displayed on the remote apparatus.

In another example, a further method is disclosed. The method can include transmitting a request for text data that is associated with multimedia content images displayed on a remote apparatus; receiving the text data such that the text data is synchronized with the multimedia content images being displayed on the remote apparatus; storing the text data in a memory; rendering a scrollable, temporal representation of the text data; and rendering a selected portion of the text data.

The aspects, features and advantages of the present principles will be appreciated when considered with reference to the following description of examples and accompanying figures.

### BRIEF DESCRIPTION OF THE DRAWINGS

FIG. 1 is an example apparatus in accordance with aspects of the present principles.

FIG. 2 is a further example apparatus in accordance with aspects of the present principles.

FIG. 3 is a flow diagram of an example method in accordance with aspects of the present principles.

FIG. 4 is a working example in accordance with aspects of the present principles.

FIG. 5 is a further flow diagram of an example method in accordance with aspects of the present principles.

FIG. 6 is a further working example in accordance with aspects of the present principles.

### DETAILED DESCRIPTION

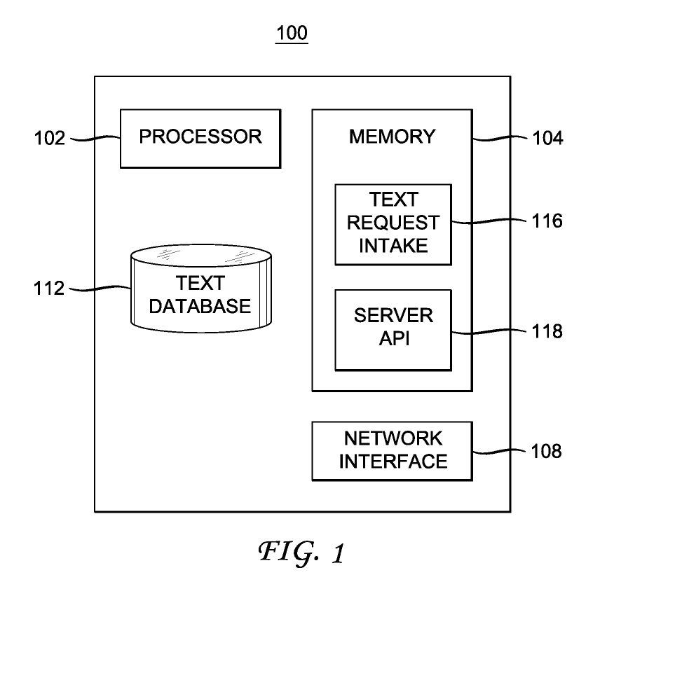

FIG. 1 presents a schematic diagram of an illustrative computer apparatus 100 that can be used as a server in accordance with the present principles. Computer apparatus 100 can comprise, as non-limiting examples, any device capable of processing instructions and transmitting data to and from other computers, including a laptop, a full-sized personal computer, a high-end server, or a network computer lacking local storage capability. Computer apparatus 100 can include all the components normally used in connection with a computer. For example, it can have a keyboard and mouse and/or various other types of input devices, such as pen-inputs, joysticks, buttons, touch screens, etc., as well as a display, which could include, for instance, a CRT, LCD, plasma screen monitor, TV, projector, etc. Computer apparatus 100 can also comprise a network interface 108 to communicate with other devices over a network.

Computer apparatus 100 can also contain at least one processor that can be arranged as different processing cores. For ease of illustration, one processor 102 is shown in FIG. 1, but it is understood that multiple processors can be employed simultaneously. Processor 102 can be any number of well-known processors, such as processors from Intel® Corporation. In another example, processor 102 can be an application specific integrated circuit (“ASIC”). Processor 102 can be implemented as a hardware processor, a digital signal processor (DSP), an ASIC, a field programmable gate array (FPGA) or other programmable logic devices, a discrete gate or transistor logic device, a discrete hardware component, or any suitable combination of processing circuitry for executing the functions described in the present principles. Processor 102 can also be implemented as a combination of computation devices, such as a combination of a DSP and a microprocessor, a plurality of microprocessors, one or more microprocessors in communication with the DSP or any other such configuration. The described devices can include processing circuits, processors, FPGAs or ASICs, each of which can be in combination with software for execution.

Memory 104 can store information accessible by processor 102, including instructions or data. Memory 104 can be any type of memory capable of storing information accessible by processor 102 including, but not limited to, a memory card, read only memory (“ROM”), random access memory (“RAM”), DVD, or other optical disks, as well as other write-capable and read-only memories. Computer apparatus 100 can include different combinations of the foregoing, whereby different portions of the instructions and data are stored on different types of media.

In another example, memory 104 can be a non-transitory computer readable medium that can include any computer readable media with the exception of a transitory, propagating signal. Examples of non-transitory computer readable media can include one of many physical media such as, for example, electronic, magnetic, optical, electromagnetic, or semiconductor media. More specific examples of suitable non-transitory computer-readable media include, but are not limited to, a portable magnetic computer diskette such as floppy diskettes or hard drives, an erasable programmable read-only memory, a portable compact disc or other storage devices that can be coupled to computer apparatus 100 directly or indirectly. The non-transitory computer readable media can also include any combination of one or more of the foregoing and/or other devices as well. While only one memory is shown in FIG. 1, computer apparatus 100 can actually comprise additional memories that can or cannot be stored within the same physical housing or location.

Network interface 108 can include hardware components (e.g., chipsets, controllers, antennas, etc.) and/or software that allow computer apparatus 100 to transmit, and/or receive data. Network interface 108 can support one or more network interfaces including, but not limited to, Wi-Fi, worldwide interoperability for microwave access (“WiMAX”), 3rd generation mobile telecommunications (“3G”), code division multiple access (“CDMA”), Ethernet, special protocols proprietary to one or more companies, and various combinations of the foregoing.

Text request intake 116 can detect a request from a remote apparatus for a text data stream associated with a multimedia content stream. Text request intake 116 can utilize server application programming interface (API) 118 to transmit, via network interface 108, the text data stream to a first remote apparatus, while the multimedia content stream is transmitted separately to a second remote apparatus. Server API 118 can include a set of routines, protocols, and tools for responding to a request for text associated with multimedia content being displayed on a separate stream. When the multimedia content and text are prerecorded, text request intake 116 can be used to synchronize the text data streamed to a first remote apparatus while the multimedia content is being rendered on a second remote apparatus. In one example, text request intake 116 can ensure that the synchronization delay between the text data stream and the multimedia content stream is no greater than approximately 3 seconds. In another example, text request intake 116 can ensure that the synchronization delay between the text data stream and the multimedia content stream is no greater than approximately 5 seconds. In yet another aspect, the multimedia content stream and the text stream can be live broadcasts; in this instance, the synchronization can already be addressed by the broadcasting entity.

Text database 112 can include text data associated with multimedia content. The text data can include timestamps that correspond to a timing of scenes in the associated multimedia content. These timestamps can be used by text request intake 116 to synchronize the text with the multimedia content, when the multimedia content and text are pre-recorded. In one example, text request intake 116 can be configured to update the text data stream using text database 112 at a rate of approximately once per second.

Although the architecture of text database 112 is not limited by any particular data structure, the data can be stored in computer registers, in a relational database as a table having a plurality of different fields and records, XML documents or flat files. The data can also be formatted in any computer-readable format. The data can comprise any information sufficient to identify the relevant information, such as numbers, descriptive text, proprietary codes, references to data stored in other areas of the same memory or different memories (including other network locations) or information that is used by a function to calculate the relevant data.

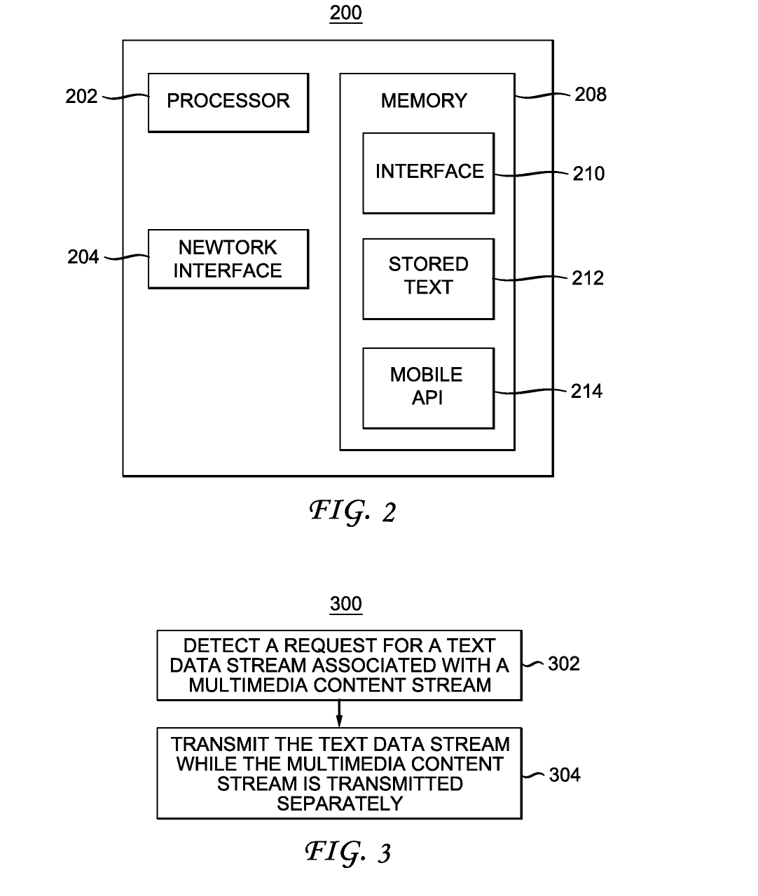

Referring now to FIG. 2, an example computer apparatus 200 is shown. Computer apparatus 200 can be used as a client apparatus that sends a request for text data to a server running in computer apparatus 100. As with computer apparatus 100, computer apparatus 200 can also include a processor 202, a memory 208, and a network interface 204, which can be similar in structure to processor 102, memory 104, and network interface 108 described above. Computer apparatus 200 can be a laptop or a full-sized personal computer. Furthermore, computer apparatus 200 can be a mobile device that includes, but is not limited to, a smart phone or tablet PC. In this instance, computer apparatus 200 can include all the components normally used in connection with mobile devices. For example, computer apparatus 200 can have a touch screen display, a physical keyboard, a virtual touch screen keyboard, a camera, a speaker, a global positioning system, a microphone, or a transceiver for transmitting long range or short range wireless signals.

Interface 210 can comprise instructions which, when executed by processor 202, renders a scrollable, temporal representation of the text data and renders a portion of the text selected by a user. As will be discussed in more detail below, interface 210 can allow a user to scroll backwards and read text associated with previous multimedia content scenes. Interface 210 can also utilize mobile API 214 to communicate with a text stream server, such as computer apparatus 100. Mobile API 214 can include a set of routines, protocols, and tools for sending text data requests to a server and receiving the text data stream. Stored text 212 can include all the received text of the text stream that can be displayed by interface 210, including text of scenes that were shown previously.

It is understood that text request intake 116, server API 118, interface 210, and Mobile API 214 can be encoded in any set of software instructions that is executable directly (such as machine code) or indirectly (such as scripts) by a processor. It can also be encoded into hardware as well. The computer executable instructions can be stored in any computer language or format, such as in object code or modules of source code. Furthermore, it is understood that text request intake 116 and interface 210 can be implemented in the form of hardware, software, or a combination of hardware and software, and that the examples herein are merely illustrative.

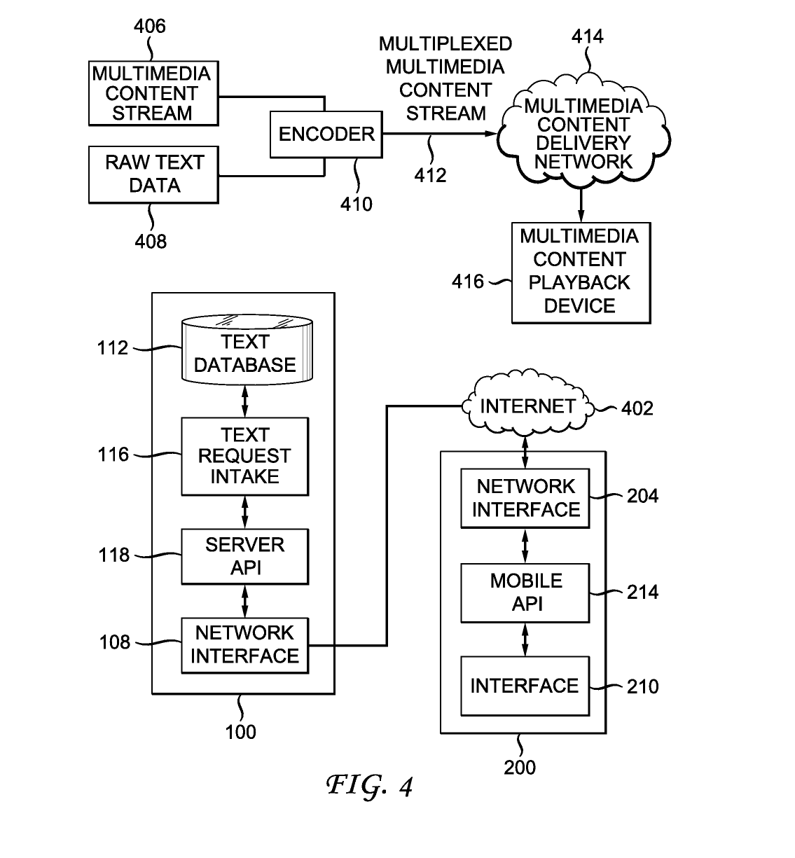

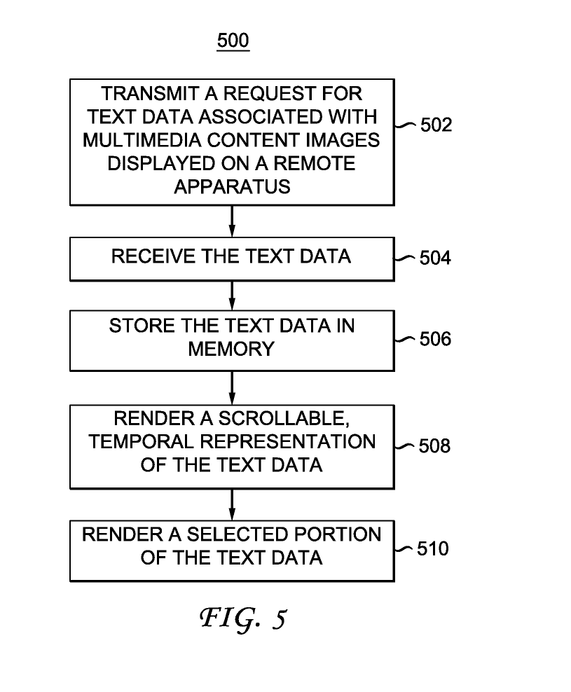

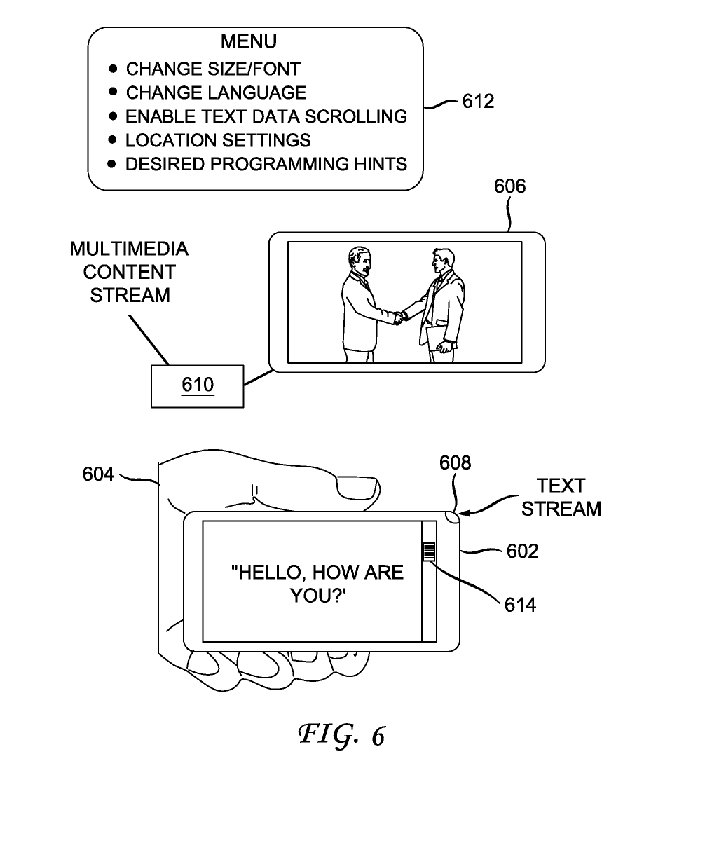

Working examples of the apparatus and method are shown in FIGS. 3-6. In particular, FIG. 3 illustrates a flow diagram of an example method 300 that can be carried out by a server executing in computer apparatus 100. FIG. 5 illustrates a flow diagram of an example method 500 that can be carried out by a client in computer apparatus 200. FIGS. 4 and 6 show working examples of the method and apparatus in accordance with aspects of the present principles. The actions shown in FIGS. 4 and 6 will be discussed below with regard to the flow diagrams in FIGS. 3 and 5 respectively.

Referring to FIG. 3, a request for a text data stream can be detected, as shown in block 302. Referring now to the example of FIG. 4, computer apparatus 100 is shown detecting a request, via network interface 108, from computer apparatus 200 over the Internet 402. In the example shown in FIG. 4, a separate multimedia content streaming entity is depicted, since the example of FIG. 4 is a live multimedia content broadcast; however, in another example, computer apparatus 100 can stream the multimedia content to a separate apparatus, when the multimedia content is pre-recorded. In the example of FIG. 4, raw text data 408 is shown being multiplexed with multimedia content stream 406 using an encoder 410 to generate multiplexed multimedia content stream 412. Multiplexed multimedia content stream 412 can be delivered over a multimedia content network 414, such as satellite network, cable network, etc. The multimedia content can be displayed on multimedia content playback device 416 and the text data can be turned on or off by viewers watching content on multimedia content playback device 416.

Referring back to FIG. 3, the text data stream can be transmitted to computer apparatus 200 while the multimedia content stream is transmitted separately, as shown in block 304. Referring back to FIG. 4, if a group of viewers watching multimedia content playback device 416 include viewers that need text data, these viewers can choose to receive the text from computer apparatus 100 and display the text on their personal device (e.g., computer apparatus 200).

Referring now to FIG. 5, a method executed by the client in computer apparatus 200 is shown. As shown in block 502, a request for text data associated with multimedia content images displayed on a remote apparatus can be transmitted, as shown in block 502. In block 504, the text data can be received; the text can be stored in a memory, as shown in block 506. Referring back to FIG. 4, computer apparatus 200 is shown requesting text from computer apparatus 100 and receiving the text using network interface 204.

Referring back to FIG. 5, a scrollable, temporal representation of the text data can be rendered, as shown in block 508. In block 510, a selected portion of the text data can be rendered. Referring now to FIG. 6, a user 604 is shown holding a mobile device 602. Mobile device 602 is shown displaying text data associated with a multimedia content being displayed on playback device 606. Playback device 606 can display multimedia content received via set top box 610, and mobile device 602 can display text data received via antenna 608. Mobile device 602 is also shown rendering a scroll bar 614 that allows user 604 to scroll backwards to read text associated with past multimedia content scenes. The text data can be temporal such that the text can be periodically updated as scenes change on playback device 606. The interface on mobile device 602 can also display a menu 612 that allows a user to alter the look and feel of the text data. The menu options shown in menu 612 include, but are not limited to, size and font, language, location settings and desired programming hints (i.e., information relating to multimedia content information displayed on a remote apparatus). Mobile device 602 can employ the location settings and related multimedia content information to obtain the correct text data such as, for example, closed captioning information for the multimedia content. A user can enter the related multimedia content information, such as a title of a movie, or an actor's name, etc. The related information can be used alone or in conjunction with the location of mobile device 602 to determine which multimedia content is currently being rendered; in turn, by determining the multimedia content, mobile device 602 can use this determination to ensure the correct text data is being retrieved and/or it can be used by the computing apparatus 100 to ensure that the correct text data is being sent to the mobile device. In some circumstances, mere knowledge of the location of the mobile device 602 can prove sufficient to determine the multimedia content. For example, the mobile device 602 can be in proximity of a movie theater, drive-in or a private showing of a particular multimedia content (e.g., viewing of a closed sporting event such as boxing match and the like shown at a known location).

Advantageously, the above-described apparatus and method allow users to view text data on their private devices without interfering with multimedia content shown on a different device. In this regard, a scrollable interface can be displayed that allows a user to read text associated with previously shown scenes. Furthermore, the text can be displayed with enhanced graphics, since the text can be displayed through its own stream without being multiplexed with multimedia content. It also permits users to enjoy their multimedia content in environments too noisy to hear audio associated with the multimedia content.

Although the disclosure herein has been described with reference to particular examples, it is to be understood that these examples are merely illustrative of the principles of the disclosure. Furthermore, while particular processes are shown in a specific order in the appended drawings, such processes are not limited to any particular order unless such order is expressly set forth herein. Rather, various steps may be handled in a different order or simultaneously, and steps may be omitted or added.

1. An apparatus comprising:
a network interface for transmitting requests and receiving text data;
a memory for storing received text data; and
at least one processor configured to:
transmit, via the network interface, a request for text data that is associated with multimedia content images displayed on a remote apparatus;
receive, via the network interface, the text data;
store the text data in the memory;
render a scrollable, temporal representation of the text data; and
render a selected portion of the text data on a display.

2. The apparatus of claim 1, wherein the text data is received from a first network while the multimedia content images are transmitted over a second network.

3. The apparatus of claim 2, wherein the first network is the Internet and the second network is a multimedia content delivery network.

4. The apparatus of claim 1, wherein the at least one processor is further configured to display the text data while corresponding multimedia content images are displayed on the remote apparatus.

5. The apparatus of claim 1, wherein the at least one processor is further configured to transmit information relating to the multimedia content images displayed on the remote apparatus.

6. A method comprising:
transmitting, by at least one processor, a request for text data that is associated with multimedia content images displayed on a remote apparatus;
receiving, by the at least one processor, the text data such that the text data is synchronized with the multimedia content images being displayed on the remote apparatus;
storing, by the at least one processor, the text data in a memory;
rendering, by the at least one processor, a scrollable, temporal representation of the text data; and
rendering, by the at least one processor, a selected portion of the text data on a display.

7. The method of claim 6, wherein the text data is received from a first network while the multimedia content images are transmitted over a second network.

8. The method of claim 7, wherein the first network is the Internet and the second network is a multimedia content delivery network.

9. The method of claim 6, further comprising displaying, by the at least one processor, the text data while corresponding multimedia content images are displayed on the remote apparatus.

10. The method of claim 6, further comprising transmitting information relating to the multimedia content images displayed on the remote apparatus.

11. An apparatus comprising:
a network interface for receiving requests and transmitting text data; and
at least one processor configured to:
detect, via the network interface, a request from a first remote apparatus for a text data stream that is associated with a multimedia content stream; and
transmit, via the network interface, the text data stream to the first remote apparatus while the multimedia content stream is transmitted separately to a second remote apparatus.

12. The apparatus of claim 11, wherein the text data stream is transmitted over a first network and the multimedia content stream is transmitted over a second network.

13. The apparatus of claim 12, wherein the first network is the Internet and the second network is a multimedia content delivery network.

14. The apparatus of claim 11, wherein the at least one processor is further configured to update the text data stream using a text database at a rate of approximately once per second.

15. The apparatus of claim 11, wherein the at least one processor is configured to identify a data rate for the text data stream that is synchronized with that of the multimedia content stream.

16. The apparatus of claim 11, wherein the text data stream and the multimedia content stream are live broadcasts.

17. The apparatus of claim 11, wherein the at least one processor is configured to synchronize the text data stream with the multimedia content stream such that a synchronization delay there between is no greater than approximately 5 seconds, the text data stream and the multimedia content stream being pre-recorded.
